(19) United States
(12) Patent Application Publication
(10) Pub. No.: US 2012/0055144 A1
(43) Pub. Date: Mar. 8, 2012

(54) METHOD FOR OPERATING A HYDRAULIC HYBRID VEHICLE

(75) Inventors: Volker Pitzal, Waldstetten/Wissgoldingen (DE); Udo Schulz, Vaihingen/Enz (DE)

(73) Assignee: ROBERT BOSCH GMBH, Stuttgart (DE)

(21) Appl. No.: 13/254,880

(22) PCT Filed: Jan. 19, 2010
(86) PCT No.: PCT/EP2010/050558

§ 371 Date: Nov. 28, 2011

(30) Foreign Application Priority Data
Mar. 5, 2009 (DE) 10 2009 001 357.1

(51) Int. Cl. F15B 1/08

(52) U.S. Cl. 60/327

(57) ABSTRACT

The invention relates to a method for operating a hydraulic hybrid vehicle (2) having a primary (5) and a hydraulic (6) drive unit, which is operated with a hydraulic medium for creating a positive or negative torque, said medium being delivered in different operational states by means of the hydraulic drive unit (6) from a hydropneumatic low pressure accumulator (12) into a hydropneumatic high pressure accumulator (11) or is discharged from the hydropneumatic high pressure accumulator (11) into the hydropneumatic low pressure accumulator (12) for driving the hydraulic drive unit (6). In order to further increase the safety and/or the driving comfort during the operation of the hydraulic hybrid vehicle having a primary drive unit and a hydraulic drive unit, the pressure and/or the temperature or a change of the pressure and/or the temperature is detected in the hydropneumatic high pressure accumulator (11) in order to monitor the torque generated by the hydraulic drive unit (6).

### BACKGROUND OF THE INVENTION

The invention relates to a method for operating a hydraulic hybrid vehicle having a primary drive unit and a hydraulic drive unit, which, to generate a positive or negative torque, is operated with a hydraulic medium which, in different operational states, is delivered from a hydropneumatic low-pressure accumulator into a hydropneumatic high-pressure accumulator with the aid of the hydraulic drive unit or discharged from the hydropneumatic high-pressure accumulator into the hydropneumatic low-pressure accumulator in order to drive the hydraulic drive unit.

International publication WO 2006/038968 A1 has disclosed a hydraulic hybrid drive with a hydraulic fluid reservoir which is fitted with a temperature sensor, a low-pressure switch and a reservoir pressure switch.

### SUMMARY OF THE INVENTION

It is the object of the invention to further enhance safety and/or driving comfort during the operation of a hydraulic hybrid vehicle having a primary drive unit and having a hydraulic drive unit.

This object is achieved, in a method for operating a hydraulic hybrid vehicle having a primary drive unit and a hydraulic drive unit, which, to generate a positive or negative torque, is operated with a hydraulic medium which, in different operational states, is delivered from a hydropneumatic low-pressure accumulator into a hydropneumatic high-pressure accumulator with the aid of the hydraulic drive unit or discharged from the hydropneumatic high-pressure accumulator into the hydropneumatic low-pressure accumulator in order to drive the hydraulic drive unit, by virtue of the fact that the pressure and/or the temperature or a change in the pressure and/or the temperature in the hydropneumatic high-pressure accumulator are or is detected in order to monitor the torque generated by the hydraulic drive unit. The primary drive unit is an internal combustion engine, for example. In the hydraulic drive unit, a hydraulic motor and a hydraulic pump are combined, for example. According to an essential aspect of the invention, the torque output of the hydraulic drive unit in the drive train of the hydraulic hybrid vehicle is continuously monitored in order to avoid an unwanted acceleration. The term “positive acceleration” is used to refer to normal acceleration, which leads to an increase in the speed of the hydraulic hybrid vehicle. The term “negative acceleration” is used to refer to braking or deceleration of the hydraulic hybrid vehicle.

A preferred illustrative embodiment of the method is characterized in that the pressure and/or the temperature or a change in the pressure and/or the temperature in a gas bubble of the hydropneumatic high-pressure accumulator are or is detected in order to monitor the torque generated by the hydraulic drive unit. The gas is preferably nitrogen. To detect the pressure and/or the temperature, a pressure and/or temperature sensor projects into the gas bubble.

Another preferred illustrative embodiment of the method is characterized in that the pressure and/or the temperature or a change in the pressure and/or the temperature in the hydropneumatic low-pressure accumulator are or is detected in order to monitor the torque generated by the hydraulic drive unit. Preferably, both the pressure and the temperature in both hydropneumatic pressure accumulators are detected.

Another preferred illustrative embodiment of the method is characterized in that the pressure and/or the temperature or a change in the pressure and/or the temperature in a gas bubble of the hydropneumatic low-pressure accumulator are or is detected in order to monitor the torque generated by the hydraulic drive unit. The hydropneumatic low-pressure accumulator can be identical in construction to the hydropneumatic high-pressure accumulator. The hydropneumatic pressure accumulators preferably comprise a pressure vessel filled with hydraulic medium and a gas bubble. The hydraulic medium is preferably hydraulic oil.

Another preferred illustrative embodiment of the method is characterized in that, during a regenerative braking operation of the hydraulic hybrid vehicle, the system detects whether and, if appropriate, how much the pressure and/or the temperature in the hydropneumatic high-pressure accumulator rise or rises and/or whether and, if appropriate, how much they/it fall or falls in the hydropneumatic low-pressure accumulator. In this case, the pressure and/or the temperature of the gas in the respective pressure accumulator is preferably detected with the aid of suitable pressure sensors and/or temperature sensors, which project into the respective gas bubbles. If regenerative braking, effected through pumping operation for example, is not sufficient or the hydropneumatic high-pressure accumulator reaches its maximum pressure, the braking operation can be additionally assisted by conventional braking

Another preferred illustrative embodiment of the method is characterized in that, in the event of a change to a driving operational state in which no acceleration or no unintentionally high acceleration of the hydraulic hybrid vehicle is desired and the hydropneumatic high-pressure accumulator is charged, the system detects whether and, if appropriate, how much the pressure and/or the temperature in the hydropneumatic high-pressure accumulator fall or falls and/or whether and, if appropriate, how much they/it rise or rises in the hydropneumatic low-pressure accumulator. In the event of an unwanted or unintentionally high acceleration of the hydraulic hybrid vehicle by the hydraulic drive unit, said drive unit can be switched off. As an alternative or in addition, a conventional brake can be activated.

Another preferred illustrative embodiment of the method is characterized in that, to check a pressure sensor/temperature sensor used to detect the pressure/temperature, the temperature/pressure or temperature change/pressure change is detected during a compression and/or an expansion of the hydropneumatic high-pressure accumulator. In this case, the temperature/pressure or temperature change/pressure change is preferably detected in the gas bubble.

Another preferred illustrative embodiment of the method is characterized in that, to check a pressure sensor/temperature sensor used to detect the pressure/temperature, the temperature/pressure or temperature change/pressure change is detected during a pressure-holding/temperature operation of the hydropneumatic high-pressure accumulator and/or of the hydropneumatic low-pressure accumulator. In this case, the temperature/pressure or temperature change/pressure change is preferably detected in the gas bubble.

Another preferred illustrative embodiment of the method is characterized in that a switch is made to a different operating mode of the hydraulic hybrid vehicle only if the detected pressure and/or the detected temperature or a detected change in the pressure and/or the temperature in the hydropneumatic high-pressure accumulator and/or in the hydropneumatic low-pressure accumulator are or is in a permissible operating range. In this case, the pressure and the temperature or the respective changes are preferably detected in the gas bubble.

### BRIEF DESCRIPTION OF THE DRAWINGS

Further advantages, features and details of the invention will emerge from the following description, in which various illustrative embodiments are described in detail with reference to the drawing.

In the drawing:

FIG. 1 shows a greatly simplified schematic illustration of a drive train of a hydraulic hybrid vehicle during a regenerative braking operation;

FIG. 2 shows the same illustration as that in FIG. 1 during acceleration by a hydraulic drive unit, and

FIG. 3 shows a charging/discharging operation in a hydropneumatic high-pressure accumulator in a p-V diagram.

### DETAILED DESCRIPTION

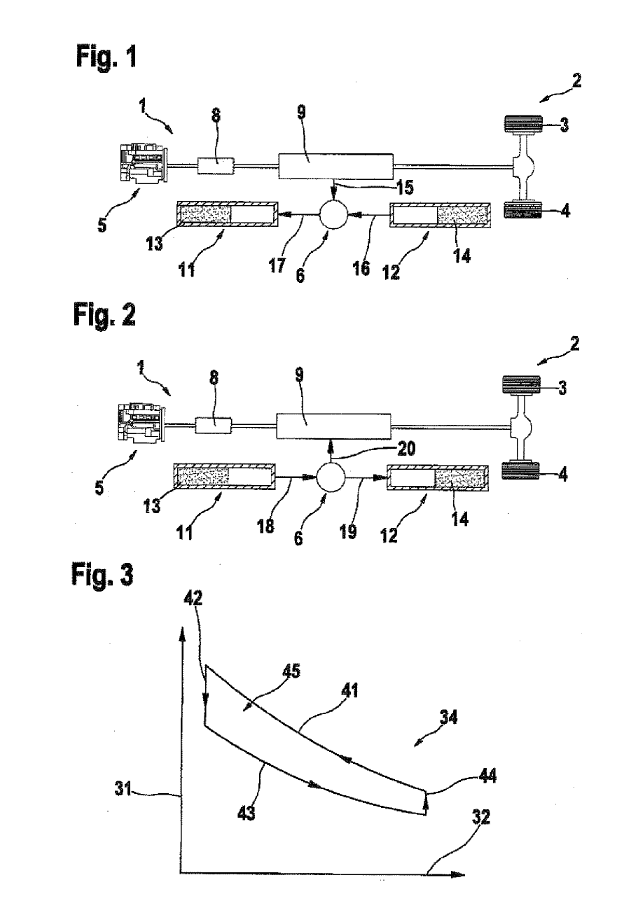

FIGS. 1 and 2 give a greatly simplified illustration of a drive train 1 of a hydraulic hybrid vehicle 2 having two driving wheels 3 and 4. The driving wheels 3 and 4 can be driven by means of a primary drive unit 5, which comprises an internal combustion engine in the illustrative embodiment shown. As an alternative or in addition, the driving wheels 3 and 4 can be driven by means of a hydraulic drive unit 6, which comprises a hydraulic pump and a hydraulic motor, for example. As an alternative, the hydraulic drive unit 6 can also comprise a hydraulic machine which can perform both the function of a hydraulic pump and the function of a hydraulic motor.

A transmission 8 is connected between the primary drive unit 5 and the driving wheels 3, 4. Connected between the transmission 8 and the driving wheels 3, 4 is a control and coupling device 9, which comprises at least one mechanical or hydrodynamic coupling and an electronic control unit, for example. By means of the control and coupling device 9, the hydraulic drive unit 6 can be coupled to the driving wheels 3, 4, preferably in addition to the primary drive unit 5.

The hydraulic drive unit 6 can be operated hydraulically with a hydraulic medium and, for this purpose, is connected hydraulically between a hydropneumatic high-pressure accumulator 11 and a hydropneumatic low-pressure accumulator 12. In addition to the hydraulic medium, the two pressure accumulators 11 and 12 each comprise a gas bubble 13, 14, which is filled with nitrogen, for example. Hydropneumatic pressure accumulators of this kind are also referred to for short as hydraulic accumulators. As an alternative, the pressure accumulators 11 and 12 can also be embodied as diaphragm-type accumulators or as piston-type accumulators. Hydraulic accumulators are capable of holding a certain volume of fluid under pressure and releasing it again with low losses.

In FIG. 1, an arrow 15 is used to indicate that the hydraulic drive unit 6 is being driven by the driving wheels 3 and 4 in a regenerative braking operation. As an alternative or in addition, the hydraulic drive unit 6 can be driven by means of the internal combustion engine 5. If the hydraulic drive unit 6 is driven as illustrated in FIG. 1, it operates as a hydraulic pump and, as indicated by arrows 16 and 17, delivers hydraulic medium from the low-pressure accumulator 12 into the high-pressure accumulator 11. During this process, the gas bubble 14 in the low-pressure accumulator 12 is relieved, and the gas bubble 13 in the high-pressure accumulator is compressed.

FIG. 3 shows a Cartesian coordinate diagram with a Y axis 31 and an X axis 32, in which the gas pressure p is shown against the gas volume V during the charging and discharging 34 of the high-pressure accumulator 11 from FIGS. 1 and 2 in the form of a p-V diagram. During the regenerative braking operation illustrated in FIG. 1, the high-pressure accumulator 11 is charged, as indicated by an arrow 41. During this process, the pressure of the gas in the gas bubble 13 increases owing to a reduction in volume. At the same time, the temperature of the gas increases. In an idle phase, indicated by another arrow 42, the gas in the gas bubble 13 releases heat to the environment. During this process, the pressure falls while the volume remains the same.

In FIG. 2, arrows 18, 19 indicate the way in which the high-pressure accumulator 11 is discharged into the low-pressure accumulator 12 in order to drive the hydraulic drive unit 6. The discharging of the high-pressure accumulator 11 is indicated in FIG. 3 by another arrow 43. In FIG. 2, another arrow 20 indicates that the energy provided by the hydraulic drive unit 6 is used to drive or accelerate the driving wheels 3 and 4. In FIG. 3, another arrow 44 indicates that the gas pressure in the gas bubble 13 of the high-pressure accumulator 11 rises again through the absorption of ambient heat in another idle phase. Since the heat losses in the idle phase are greater than the gains during the charging operation, an area 45 in FIG. 3 within the characteristic 34 representing the charging and discharging operation is identical with the heat losses.

According to an essential aspect of the invention, the pressure and/or temperature or the change in these variables in the gas bubble 13 of the high-pressure accumulator 11 and, optionally, in the gas bubble 14 of the low-pressure accumulator 12 are or is detected and monitored. The detected pressure and/or temperature values are used during the operation of the hydraulic hybrid vehicle 2 in order to detect unwanted acceleration processes or decelerations that do not occur.

In one illustrative embodiment of the invention, the focus is on monitoring the loss or absence of deceleration of the hydraulic hybrid vehicle 2 by means of pressure and, optionally, temperature measurement in the gas bubble 13 of the high-pressure accumulator 11 and/or in the gas bubble 14 of the low-pressure accumulator 12. If the operational state of the hydraulic hybrid vehicle 2 changes to the regenerative braking mode, sufficient deceleration of the vehicle to avoid endangering people and goods must be ensured. According to the invention, a pressure sensor and, optionally, a temperature sensor are installed in the high-pressure and, optionally, in the low-pressure accumulator, each of said sensors projecting into the gas bubble. The monitoring method is based on monitoring pressure and, optionally, temperature or changes therein in the gas-bubble accumulators during compression in the high-pressure accumulator and, optionally, expansion in the low-pressure accumulator. If the regenerative braking operation is correct, the pressure and temperature in the gas bubble of the high-pressure accumulator must increase and those in the gas bubble of the low-pressure accumulator must decrease.

It is assumed that the operating mode coordinator switches to the deceleration or braking mode. If the current pressure in the high-pressure gas-bubble accumulator is within the permissible operating range and the difference with respect to the maximum permissible pressure of the service accumulator is sufficient for a minimum defined amount of braking work, the regenerative braking mode is activated. Otherwise, the conventional mechanical hydraulic braking mode is activated. Activating the regenerative braking mode also at the same time activates the monitoring and safety functions which follow in accordance with the invention.

A pressure sensor/temperature sensor plausibility check is carried out as follows. Some of the energy supplied during compression produces an increase in the temperature of the gas in the high-pressure gas-bubble accumulator. Some of the energy dissipated during expansion produces a reduction in the temperature in the low-pressure gas-bubble accumulator. In order to check the pressure sensor, the invention specifies that the temperature be measured during compression and, optionally, during expansion. A pressure increase (pressure difference/time) is compared with a temperature increase (temperature difference/time) for the high-pressure gas-bubble accumulator and, optionally, a pressure reduction (pressure difference/time) is compared with a temperature reduction (temperature difference/time) for the low-pressure gas-bubble accumulator.

To detect and respond to a fault when there is a defect in the sensor, the procedure is as follows. If the absolute values for pressure and temperature and the paired values for the pressure change and temperature change are within a permissible tolerance band during measurement, it can be assumed that the sensors are functioning correctly, both statically and dynamically. Otherwise, a fault is indicated and the conventional mechanical hydraulic braking mode is activated. As an alternative or in addition, a clutch can be disengaged in order to prevent an unwanted acceleration.

As is known, the area under the curve of 41 is the compression work and is therefore proportional to the braking work in the hybrid vehicle with a hydraulic motor/pump. According to the invention, the pressure of 41 is measured against time, this being basically proportional to the braking power. This is compared with a desired braking power in the driving software of a drive train control unit. If there is no braking power or the braking power is too low, owing, for example, to a faulty pump or a leak in the system or a faulty pump coupling or faulty hydraulic valves etc., the monitoring function indicates a fault, and the conventional mechanical hydraulic brake is activated. Also conceivable is a complete switch to the conventional mechanical hydraulic brake or, as an alternative, the conventional mechanical hydraulic brake can supply the amount lacking

If the operational state of the vehicle changes to a mode in which no acceleration of the vehicle is desired, as in overrun operation or during a braking operation, for example, and the gas-bubble high-pressure accumulator is charged, there is a need to prevent acceleration of the vehicle by the hydraulic motor. According to the invention, a pressure sensor and, optionally, a temperature sensor are installed in the high-pressure accumulator and, optionally, in the low-pressure accumulator, each of said sensors projecting into the gas bubble. The monitoring method is based on monitoring pressure and, optionally, temperature or changes therein in the gas-bubble accumulators during pressure holding in the high-pressure accumulator and, optionally, in the low-pressure accumulator. Regenerative braking is complete or is not active. If no acceleration of the vehicle is desired, as in overrun operation or during a braking operation for example, there must be no impermissible pressure reduction and, optionally, temperature reduction in the gas bubble of the high-pressure accumulator and no impermissible pressure increase and, optionally, temperature increase in the gas bubble of the low-pressure accumulator, allowing for heat dissipation to and heat absorption from the environment.

It is assumed that the mode coordinator switches to the deceleration or braking mode and that the gas-bubble high-pressure accumulator is charged. Activation of the pressure holding mode also at the same time activates the monitoring and safety function which follows in accordance with the invention.

Some of the energy supplied during compression produces an increase in the temperature of the gas in the high-pressure gas-bubble accumulator. On the other hand, some of the energy dissipated during expansion produces a reduction in the temperature in the low-pressure gas-bubble accumulator. In order to check the pressure sensor, the invention specifies that the temperature be measured while the pressure is being held. A permissible pressure change (pressure difference/time) is compared with a temperature change (temperature difference/time) for the high-pressure gas-bubble accumulator and, optionally, a pressure change (pressure difference/time) is compared with a temperature change (temperature difference/time) for the low-pressure gas-bubble accumulator. If the gas in the high-pressure bubble accumulator is at a higher temperature than the environment, the temperature and pressure fall in accordance with the temperature difference, heat transfer coefficient and time. If the gas in the low-pressure bubble accumulator is at a lower temperature than the environment, the temperature and pressure rise in accordance with the temperature difference, heat transfer coefficient and time.

To detect and respond to a fault when there is a defect in the sensor, the procedure is as follows. If the absolute values for pressure and temperature and also the paired values for the pressure change and temperature change are within a permissible tolerance band during measurement, it can be assumed that the sensors are functioning correctly, both statically and dynamically. Otherwise, a fault is indicated and the regenerative braking mode and acceleration by means of the hydraulic motor are no longer permitted.

According to the invention, the heat transfer in the high-pressure and, optionally, in the low-pressure gas-bubble accumulator are calculated or estimated in the control unit. For this purpose, the temperature of the environment of the gas is measured or derived from other measured variables in the system, e.g. the ambient temperature, oil temperature and the like, by means of a temperature model. The heat conduction coefficients of the materials are known. The time for pressure holding can be measured by the control unit itself. Allowing for permissible leakage in the hydraulic system, the pressure and temperature drop in the high-pressure accumulator should not exceed a certain amount. Allowing also for permissible leakage in the hydraulic system, the pressure and temperature rise in the low-pressure accumulator should not exceed a certain amount.

In the case where the amounts for the high-pressure and the low-pressure gas-bubble accumulator are exceeded and it is not possible to assume definitively that the clutch of the hydraulic motor is disengaged from the drive train, unwanted acceleration can be assumed. In this case, a fault should be indicated and/or the conventional mechanical hydraulic brake should be activated and/or additional loads on the drive train should be connected up and/or the gas-bubble high-pressure accumulator should be switched to a depressurized condition.

In the case where the amount is exceeded only for the high-pressure gas-bubble accumulator, a leak or leakage in the hydraulic system must be assumed. A fault must be indicated and the hydraulic motor/pump must be inactivated.

In maintaining constant running or acceleration, assisted by the hydraulic motor and the contribution thereof to propulsion, there must not be an unintentionally high contribution and hence an unwanted acceleration of the vehicle.

Some of the energy dissipated during expansion produces a reduction in the temperature of the gas in the high-pressure gas-bubble accumulator. On the other hand, some of the energy supplied during compression produces an increase in the temperature in the low-pressure gas-bubble accumulator. In order to check the pressure sensor, the invention specifies that the temperature be measured during expansion and, optionally, during compression. A pressure reduction (pressure difference/time) is compared with a temperature reduction (temperature difference/time) for the high-pressure gas-bubble accumulator and, optionally, a pressure increase (pressure difference/time) is compared with a temperature increase (temperature difference/time) for the low-pressure gas-bubble accumulator.

If the absolute values for pressure and temperature during the measurement and the paired values for the pressure change and temperature change are within a permissible tolerance band, it can be assumed that the sensors are functioning correctly, both statically and dynamically. Otherwise, a fault is indicated and the hydraulic motor is disconnected from the drive train.

As is known, the area under the curve 43 is the expansion work and is therefore proportional to the work contribution of the hydraulic motor in the hybrid vehicle. According to the invention, the pressure of 43 is measured against time, this being basically proportional to the power output of the hydraulic motor in the hybrid vehicle. This is compared with a permissible power in the driving software of the drive train control unit. If the power is too high, owing, for example, to a faulty motor or faulty hydraulic valves etc., the monitoring function indicates a fault, and, the hydraulic motor is normally shut off and/or the conventional mechanical hydraulic brake is activated. A complete switch to the internal combustion engine is conceivable. As an alternative, the power of the internal combustion engine is reduced by the excessive amount supplied by the hydraulic motor.

The proportional, in particular nonlinear, relationships between the physical variables in the chains of action described are applied in characteristics or characteristic maps, for example. In the case of physical relationships by means of polynomials, the polynomial parameters must be applied. Application is generally accomplished using a reference (vehicle, test bed) and also allows for permissible tolerances.

1. A method for operating a hydraulic hybrid vehicle (2) having a primary drive unit (5) and a hydraulic drive unit (6), which, to generate a positive or negative torque, is operated with a hydraulic medium which, in different operational states, is delivered from a hydropneumatic low-pressure accumulator (12) into a hydropneumatic high-pressure accumulator (11) with the aid of the hydraulic drive unit (6) or discharged from the hydropneumatic high-pressure accumulator (11) into the hydropneumatic low-pressure accumulator (12) in order to drive the hydraulic drive unit (6), characterized in that one or more first conditions in the hydropneumatic high-pressure accumulator (11) are detected in order to monitor the torque generated by the hydraulic drive unit (6).

2. The method as claimed in claim 1, characterized in that one or more second conditions in a gas bubble (13) of the hydropneumatic high-pressure accumulator (11) are detected in order to monitor the torque generated by the hydraulic drive unit (6).

3. The method as claimed in claim 1, characterized in that one or more third conditions in the hydropneumatic low-pressure accumulator (12) are detected in order to monitor the torque generated by the hydraulic drive unit (6).

4. The method as claimed in claim 1, characterized in that one or more fourth conditions in a gas bubble (14) of the hydropneumatic low-pressure accumulator (12) are or is detected in order to monitor the torque generated by the hydraulic drive unit (6).

5. The method as claimed in claim 1, characterized in that, during a regenerative braking operation of the hydraulic hybrid vehicle (2), the system detects a pressure and/or the temperature rise in the hydropneumatic high-pressure accumulator (11) and/or a pressure and/or the temperature fall in the hydropneumatic low-pressure accumulator (12).

6. The method as claimed in claim 1, characterized in that, in the event of a change to a driving operational state in which no acceleration or no unintentionally high acceleration of the hydraulic hybrid vehicle (2) is desired and the hydropneumatic high-pressure accumulator (11) is charged, the system detects a pressure and/or the temperature fall in the hydropneumatic high-pressure accumulator (11) and/or a pressure and/or the temperature rise in the hydropneumatic low-pressure accumulator (12).

7. The method as claimed in claim 1, characterized in that, to check a pressure sensor/temperature sensor used to detect the pressure/temperature, the temperature/pressure or temperature change/pressure change is detected during a compression and/or an expansion of the hydropneumatic high-pressure accumulator (11).

8. The method as claimed in claim 1, characterized in that, to check a pressure sensor/temperature sensor used to detect the pressure/temperature, the temperature/pressure or temperature change/pressure change is detected during a pressure-holding operation of the hydropneumatic high-pressure accumulator (11) and/or of the hydropneumatic low-pressure accumulator (12).

9. The method as claimed in claim 3, characterized in that a switch is made to a different operating mode of the hydraulic hybrid vehicle (2) only if the detected first condition in the hydropneumatic high-pressure accumulator (11) and the detected third condition in the hydropneumatic low-pressure accumulator (12) are in a permissible operating range.

10. The method as claimed in claim 1, characterized in that the first condition is a temperature and/or a pressure.

11. The method as claimed in claim 1, characterized in that the first condition is a change in a temperature and/or a change in a pressure.

12. The method as claimed in claim 2, characterized in that the second condition is a temperature and/or a pressure.

13. The method as claimed in claim 2, characterized in that the second condition is a change in a temperature and/or a change in a pressure.

14. The method as claimed in claim 3, characterized in that the third condition is a temperature and/or a pressure.

15. The method as claimed in claim 3, characterized in that the third condition is a change in a temperature and/or a change in a pressure.

16. The method as claimed in claim 4, characterized in that the fourth condition is a temperature and/or a pressure.

17. The method as claimed in claim 4, characterized in that the fourth condition is a change in a temperature and/or a change in a pressure.

18. The method as claimed in claim 1, characterized in that a switch is made to a different operating mode of the hydraulic hybrid vehicle (2) only if the detected first condition in the hydropneumatic high-pressure accumulator (11) is in a permissible operating range.

19. The method as claimed in claim 3, characterized in that a switch is made to a different operating mode of the hydraulic hybrid vehicle (2) only if the detected third condition in the hydropneumatic low-pressure accumulator (12) is in a permissible operating range.
